(19) United States
(12) Patent Application Publication
(10) Pub. No.: US 2005/0057174 A1
(43) Pub. Date: Mar. 17, 2005

(54) Plasma display panel, and method and apparatus of driving the same

(76) Inventors: Jung Hun Kim, Seoul (KR); Seong Ju Yoon, Seoul (KR); Byoung Kuk Min, Seoul (KR)

Correspondence Address: FLESHNER & KIM, LLP, P.O. BOX 221200, CHANTILLY, VA, 20153, US

(21) Appl. No.: 10/911,739

(22) Filed: Aug. 5, 2004

(30) Foreign Application Priority Data
Aug. 6, 2003 (KR) 10-2003-0054434
Aug. 18, 2003 (KR) 10-2003-0056966
Sep. 30, 2003 (KR) 10-2003-0067938

(51) Int. Cl. G09G 3/10

(52) U.S. Cl. 315/169.3; 315/169.4

(57) ABSTRACT

The present invention relates to a plasma display panel in which the time necessary for addressing is shortened, and a method and apparatus for driving the PDP. A plasma display panel according to a first embodiment of the present invention includes an upper substrate in which scan electrodes and sustain electrodes are formed, and a lower substrate in which an address electrode, a horizontal diaphragm and a vertical diaphragm are formed, wherein the horizontal diaphragms and the vertical diaphragms intersect one another to form a plurality of discharge cells, and the discharge cell includes a main discharge cell on which phosphors are coated, and a sub discharge cell on which magnesium oxide is coated. According to the first embodiment of the present invention, first horizontal diaphragms and second horizontal diaphragms are provided to form main discharge cells and sub discharge cells. A priming discharge is generated and an address discharge is generated within the sub discharge cells on which magnesium oxide is coated. An address discharge occurs rapidly.

This Nonprovisional application claims priority under 35 U.S.C. § 119(a) on Patent Application No. 10-2003-0054434 filed in Korea on Aug. 6, 2003, Application No. 10-2003-0056966 filed in Korea on Aug. 18, 2003, and Application No. 10-2003-0067938 filed in Korea on Sep. 30, 2003, the entire contents of which are hereby incorporated by reference.

### BACKGROUND OF THE INVENTION

1. Field of the Invention

The present invention relates to a plasma display panel (hereinafter, referred to as a “PDP”), and more particularly, to a PDP, and a method and an appratus for driving the PDP.

2. Description of the Background Art

A PDP is adapted to display an image by light-emitting phosphors with ultraviolet rays generated during the discharge of an inert mixed gas such as He+Xe or Ne+Xe. This PDP can be easily made thin and large, and it can provide greatly enhanced image quality with the recent development of the relevant technology. Particularly, a 3-electrode AC surface discharge type PDP has advantages of lower driving voltage and longer product lifespan as a wall charge is accumulated on a surface in discharging and electrodes are protected from sputtering caused by discharging.

FIG. 1 is a perspective view illustrating the construction of a discharge cell of a conventional 3-electrode AC surface discharge type PDP.

Referring now to FIG. 1, the 3-electrode AC surface discharge type PDP includes a plurality of scan electrodes Y and a plurality of sustain electrodes Z which are formed on the bottom surface of an upper substrate 10, and an address electrode X formed on a lower substrate 18.

The discharge cell of the PDP is formed every crossing of the scan electrodes Y, the sustain electrodes Z and the address electrodes X and is arranged in a matrix shape.

Each of the scan electrode Y and the sustain electrode Z includes a transparent electrode 1 2, and a metal bus electrode 11 that has a line width smaller than the transparent electrode 12 and is disposed at one side of the transparent electrode.

The transparent electrode 12, which is generally made of ITO (indium tin oxide), is formed on the bottom surface of the upper substrate 10 and serves to reduce a voltage drop caused by the transparent electrode 12 having high resistance. On the bottom surface of the upper substrate 10 in which the scan electrodes Y and the sustain electrodes Z are disposed is laminated an upper dielectric layer 13 and a protective layer 14. The upper dielectric layer 13 is accumulated with a wall charge generated during plasma discharging. The protective layer 14 is adapted to prevent damages of the electrodes Y and Z and the upper dielectric layer 13 due to sputtering caused during plasma discharging, and improve efficiency of secondary electron emission. As the protective layer 14, magnesium oxide (MgO) is generally used.

The address electrodes X are formed on the lower substrate 18 in the direction that they intersect the scan electrodes Y and the sustain electrodes Z. A phosphor layer 16 is coated on the surfaces of both a lower dielectric layer 17 and the diaphragm 15. The phosphor layer 16 is excited with an ultraviolet generated during the plasma discharging to generate any one visible light of red, green and blue lights.

An inert mixed gas such as He+Xe, Ne+Xe or He+Xe+Ne for discharge is inserted into the discharge space of the discharge cells provided between the upper and lower substrates 10 and 18 and the diaphragms 15.

FIG. 2 shows a conventional one frame containing eight sub fields in a method for driving a conventional PDP.

Referring to FIG. 2, such a 3-electrode AC surface discharge type PDP is driven in such a way that one frame is divided into several sub fields of different emission numbers in order to implement the gray level of an image. If an image is to be represented using 256 gray levels, a frame period (16.67 ms) corresponding to 1/60 second is divided into 8 sub fields SF1 to SF8, as shown in FIG. 2. Each of the sub fields SF1 to SF8 is divided into a reset period for initializing a discharge cell, an address period for selecting a discharge cell, and a sustain period for implementing the gray level according to the number of discharge. The reset period and the address period of each of the sub fields SF1 to SF8 are the same every sub field, whereas the sustain period and its discharge number increase in the ratio of 2ⁿ (n=0,1, 2,3,4,5,6,7) in each sub field.

It is, however, difficult to arbitrarily reduce the address period of the PDP. Thus, if sub fields are added so as to increase resolution or reduce contour noise in a motion picture, there is a problem that it is difficult to secure the sustain period sufficiently.

For example, if the time for an address discharge is 3 μs. The address period necessary for one sub field in resolution of VGA 640×480 is 3 μs×480=1.44 ms. Further, if the reset period needed for each sub field is approximately 300 to 600 μs and eight sub fields as shown in FIG. 2 are included in one frame period (16.67 ms), a total of the reset period and the address period that are necessary for one frame period in resolution of VGA grade is (1.44 ms×8)+((0.3 to 0.6 ms)×8)=13.92 to 16.32 ms. Therefore, the sustain period except for the reset period and the address period is 16.67 ms−(13.92 to 16.32 ms)=0.35 to 2.75 ms, which is amount to only 2.09 to 16.5% of one frame period.

If resolution becomes XGA 1024×768, the address period necessary for one sub field is 3 μs×768=2.3 ms. If the reset period for one sub field is approximately 300 to 600 μs and eight sub fields are included in one frame period in resolution of XGA, a total of the reset period and the address period within one frame period is 2.3 ms×8+((0.3 to 0.6 ms)×8)=20.8 to 23.2 ms. Accordingly, the sustain period except for the reset period and the address period is 16.67 ms−(20.8 to 23.2 ms)=−6.53 to −4.13 ms. If eight sub fields are allocated to one frame in the XGA grade, it is difficult to secure the sustain period without reducing the time for the address discharge.

In order to solve the shortage of the driving time, there was proposed a method wherein a PDP is divided into an upper section and a lower section and both the upper section and the lower section are dual-scanned (double-scanned). This dual scan method has a disadvantage that approximately twice as many as the number of a data drive circuit is needed since data have to be supplied to each of the upper section and the lower section of the PDP individually.

Therefore, the conventional PDP is difficult to secure the sustain period because the address period is long. Accordingly, there is a problem that it is sensitive to counter noise in a motion picture because brightness is low and the number of the sub field cannot be extended.

The conventional well type diaphragm structure will now be described in detail with reference to FIG. 1.

FIGS. 3, 5 and 7 are plane views illustrating a well type diaphragm structure of a conventional surface discharge type AC plasma display panel. FIGS. 4, 6 and 8 are plane views illustrating that bus electrodes are located right on horizontal diaphragms while including the diaphragm structure of FIGS. 3, 5 and 7.

The well type diaphragm will be first described with reference to FIG. 3. The diaphragm includes a plurality of horizontal diaphragms 211a, 211b and 211c formed in the horizontal direction and a plurality of vertical diaphragm 212a, 212b and 212c formed in the vertical direction in order to prevent an erroneous discharge among neighboring cells 213a, 213b and 213c, both of which are disposed on a lower glass substrate (not shown). In other words, the well type diaphragm has a shape that the cells 213a, 213b and 213c are surrounded by the horizontal diaphragms 211a, 211b and 211c and the vertical diaphragm 212a, 212b and 212c.

Referring to FIG. 4, transparent electrodes 217 and 218 are disposed on the cell. Bus electrodes 215 and 216 are spaced by some distance from the top of the horizontal diaphragms 211a, 211b and 211c and are disposed at both side of the horizontal diaphragms 211 a, 211b and 211c one by one.

However, in the surface discharge type AC PDP having the above well type diaphragm structure, the ratio of a region through which light can pass which occupies the area of each of the cells 213a, 213b and 213c, which is one of the important factors to decide brightness, i.e., the aperture ratio, is significantly low. Therefore, the PDP has a problem that brightness and efficiency are low.

In order to solve this problem, a PDP having a well type diaphragm structure as shown in FIG. 5 or FIG. 6 was proposed. That is, in FIG. 5 or 6, a width of horizontal diaphragms 221a, 221b and 221c is thicker than the horizontal diaphragms 211a, 211b and 211c shown in FIG. 3 or 4.

In the PDP having the diaphragm structure as shown in FIG. 5 or FIG. 6, however, invalid power is increased due to increase in capacitance between a data electrode (not shown) and an upper electrode. For this reason, there is a problem in that power consumption of the whole panel increases.

In order to solve the above problem, a PDP having a diaphragm structure as shown in FIG. 7 or FIG. 8 was proposed. In FIGS. 7 or FIG. 8, horizontal grooves 236a, 236b and 236c having a given width and height are formed on the horizontal diaphragm 231a, 231b and 231c shown in FIG. 5 or FIG. 6 in the horizontal direction.

From the above, it can be seen that FIG. 6 and FIG. 8 include the bus electrode and the transparent electrode while having the diaphragm structure as shown in FIG. 5 and FIG. 7 in the same manner as the description made with reference to FIG. 4.

In the PDP having the diaphragm structure as shown in FIG. 7 or FIG. 8, invalid power reduces since capacitance between the upper electrode and the lower electrode reduces. Further, exhaust performance is also improved because the grooves serve as exhaust passages. However, capacitance between the lower electrode and the upper electrode still remains high since the bus electrodes are disposed on the diaphragms.

Moreover, a representative diaphragm structure of this PDP includes a stripe type as shown in FIG. 9 and a closed type as shown in FIG. 10. A Fish Bone type as shown in FIG. 11 has been recently developed.

Stripe type diaphragms 15 as shown in FIG. 9 are formed between the address electrodes X only in the direction of address electrodes X, thus physically separating discharge cells that are adjacent in the horizontal direction. The stripe type diaphragms 15 have an advantage that exhaust can be easily used in an exhaust process of the PDP since spaces between cells adjacent in the vertical direction are not shut. However, the stripe type diaphragms 15 have a disadvantage that they lower brightness and efficiency of the PDP because an area on which phosphors are coated is small.

On the contrary, closed type diaphragms 45 as shown in FIG. 10 are formed in the same direction as the address electrodes X between the address electrodes X. The closed type diaphragms 45 include vertical diaphragms 45b that physically separate discharge cells adjacent in the horizontal direction, and horizontal diaphragms 45a that are formed between the vertical diaphragms 45b to physically separate discharge cells adjacent in the vertical direction.

The closed type diaphragm 45 has an advantage that the coating area of phosphors is wider than the stripe type diaphragm, but has a disadvantage that it makes exhaust in the exhaust process of the PDP difficult since the diaphragms almost shut the exhaust passages in the respective horizontal and vertical directions.

A Fish Bone type diaphragm 55 as shown in FIG. 11 includes vertical diaphragms 55b that are formed in the same direction as the address electrodes X between address electrodes X to physically separate discharge cells adjacent in the horizontal direction, and horizontal diaphragms 55a that are formed in the respective vertical diaphragm 55b in the vertical direction of the vertical diaphragms 55b so that an exhaust passage is formed at the center, thus physically separating discharge cells adjacent in the vertical direction.

The Fish Bone type diaphragm 55 has advantages that the coating area of phosphors is wider than the stripe type diaphragm 15 and it is easy to secure an exhaust passage compared to the closed type diaphragm 45.

However, although the diaphragm structure as shown in FIG. 9 to FIG. 11 is adopted, the aforementioned PDP has a problem that its efficiency does not reach a satisfactory level. Furthermore, if the amount of Xe is increased in a discharge gas so as to increase resolution or efficiency, there is a problem in that an address discharge is delayed, i.e., an address jitter value increases to make a driving time short. If the address discharge delay time becomes longer, the address period becomes longer and the sustain period becomes shorter that much. It is thus difficult to divide or add sub fields so as to reduce factors that degrade image quality such as contour noise.

Furthermore, the aforementioned PDP has problems that the aperture ratio is low and brightness is degraded due to the metal bus electrode 11 since the metal bus electrode 11 traverses an effective display surface within the discharge cell.

### SUMMARY OF THE INVENTION

Accordingly, an object of the present invention is to solve at least the problems and disadvantages of the background art.

An object of the present invention to provide a PDP in which time for addressing is shortened, and a method and apparatus for driving the PDP.

Another object of the present invention is to provide a surface discharge type AC type PDP having a well type diaphragm structure in which capacitance between data electrodes and upper electrodes are reduced, thus reducing invalid power.

Further another object of the present invention is to provide a PDP in which emission efficiency is high and address high-speed driving is possible, and a method and apparatus for driving the same.

According to a first embodiment of the present invention, there is provided a plasma display panel including an upper substrate in which scan electrodes and sustain electrodes are formed, and a lower substrate in which address electrodes, horizontal diaphragms and vertical diaphragms are formed, wherein the horizontal diaphragms and the vertical diaphragms intersect one another to form a plurality of discharge cells, and the discharge cell comprises a main discharge cell on which phosphors are coated, and a sub discharge cell on which magnesium oxide is coated.

According to a first embodiment of the present invention, there is provided a method for driving a plasma display panel in which horizontal diaphragms and vertical diaphragms are intersected to form a plurality of discharge cells, including the steps of: allowing sub discharge cells on which magnesium oxide is coated within the discharge cells to generate a priming discharge; and allowing main discharge cells on which phosphors into which priming charged particles generated by the priming discharge are introduced are coated to generate an address discharge.

According to a first embodiment of the present invention, there is provided an apparatus for driving a plasma display panel in which horizontal diaphragms and vertical diaphragms are intersected to form a plurality of discharge cells, the horizontal diaphragms and the vertical diaphragms including: a plurality of discharge cells that are intersected one another, wherein the discharge cells are divided into main discharge cells on which phosphors are coated and sub discharge cells on which magnesium oxide is coated; and a driving circuit that generates a priming discharge within the sub discharge cells and generates an address discharge within the main discharge cells using priming charged particles generated by the priming discharge.

According to a second embodiment of the present invention, there is provided a surface discharge type AC type plasma display panel including horizontal diaphragms and vertical diaphragms that are formed on a lower substrate to separate respective cells, and bus electrodes formed under an upper substrate, wherein the plasma display panel has a diaphragm structure in which the horizontal diaphragms are thicker in width than the vertical diaphragms, wherein horizontal grooves having a predetermined width and height are formed in the horizontal diaphragms that separate upper cells and lower cells adjacent in the horizontal direction, and when the upper substrate and the lower substrate are combined, bus electrodes are disposed right on the horizontal grooves in the horizontal direction.

According to a third embodiment of the present invention, there is provided a plasma display panel, including: a main discharge cell; a sub discharge cell adjacent to the main discharge cell; a diaphragm having a plurality of horizontal diaphragms that separates the main discharge cell and the sub discharge cell, and a plurality of vertical diaphragms connected to the horizontal diaphragms; and an exhaust/charge passage that penetrates the horizontal diaphragms, for guiding charged particles generated from the sub discharge cell to the main discharge cell.

According to a third embodiment of the present invention, there is provided a method for driving a plasma display panel including a main discharge cell, a sub discharge cell adjacent to the main discharge cell, a diaphragm having a plurality of horizontal diaphragms that separates the main discharge cell and the sub discharge cell, and a plurality of vertical diaphragms connected to the horizontal diaphragms, and an exhaust/charge passage that penetrates the horizontal diaphragms, for guiding charged particles generated from the sub discharge cell to the main discharge cell, the method including the step of causing a discharge to occur in the main discharge cell using priming charged particles generated from the sub discharge cell.

According to a third embodiment of the present invention, there is provided an apparatus for driving a plasma display panel including a main discharge cell, a sub discharge cell adjacent to the main discharge cell, a diaphragm having a plurality of horizontal diaphragms that separates the main discharge cell and the sub discharge cell, and a plurality of vertical diaphragms connected to the horizontal diaphragms, and an exhaust/charge passage that penetrates the horizontal diaphragms, for guiding charged particles generated from the sub discharge cell to the main discharge cell, the apparatus includes a driving unit for causing a discharge to occur in the main discharge cell using priming charged particles generated from the sub discharge cell.

### BRIEF DESCRIPTION OF THE DRAWINGS

The invention will be described in detail with reference to the following drawings in which like numerals refer to like elements.

FIG. 1 is a perspective view illustrating the construction of a discharge cell of a conventional 3-electrode AC surface discharge type PDP.

FIG. 2 shows a conventional one frame containing eight sub fields in a method for driving the conventional PDP.

FIGS. 3, 5 and 7 are plane views illustrating a well type diaphragm structure of a surface discharge type AC PDP in the related art.

FIGS. 4, 6 and 8 are plane views illustrating that bus electrode is disposed right on horizontal diaphragms while including the diaphragm structure shown in FIGS. 3, 5 and 7.

FIG. 9 is a plane view illustrating a conventional stripe type diaphragm.

FIG. 10 is a plane view illustrating a conventional closed type diaphragm.

FIG. 11 is a plane view illustrating a conventional Fish Bone type diaphragm.

FIG. 12 shows a state where an upper plate and a lower plate of the PDP according to the present invention are separated.

FIG. 13 is a view shown to explain an electrode and diaphragm structure of the PDP according to the present invention.

FIG. 14 is a cross-sectional view illustrating a portion taken along lines I-I′ in FIG. 13.

FIG. 15 is a cross-sectional view illustrating a portion taken along lines X-X′ in FIG. 13.

FIG. 16 shows an apparatus for driving the PDP according to the present invention.

FIG. 17 shows a method for driving the PDP according to the present invention.

FIG. 18 is a graph illustrating the number of ions in case where magnesium oxide is coated and not coated on the sub discharge cell.

FIG. 19 is a plane view illustrating a well type diaphragm structure of a surface discharge type AC PDP according to a second embodiment of the present invention.

FIG. 20 is a plane view illustrating a state where bus electrodes are disposed immediately on horizontal grooves while including the diaphragm structure of FIG. 19.

FIG. 21 is a plane view illustrating a well type diaphragm structure of a surface discharge type AC PDP according to a variation of the second embodiment of the present invention.

FIG. 22 is a plane view illustrating a state where bus electrodes are disposed right on horizontal grooves while including the diaphragm structure of FIG. 21.

FIG. 23 is a plane view illustrating a well type diaphragm structure of a surface discharge type AC PDP according to another variation of the second embodiment of the present invention.

FIG. 24 is a plane view illustrating a state where bus electrodes are disposed right on horizontal grooves while including the diaphragm structure of FIG. 23.

FIG. 25 is a dismantled perspective view illustrating a PDP according to a third embodiment of the present invention.

FIG. 26 is a plane view illustrating the arrangement of electrodes and the diaphragms of the PDP shown in FIG. 25.

FIG. 27 shows a PDP and an apparatus for driving the PDP according to a third embodiment of the present invention PDP.

FIG. 28 shows a driving waveform of a PDP according to a third embodiment of the present invention PDP, which is generated from the driving apparatus shown in FIG. 27.

FIG. 29 is a plane view illustrating movement of priming charged particles that are generated from a sub discharge cell.

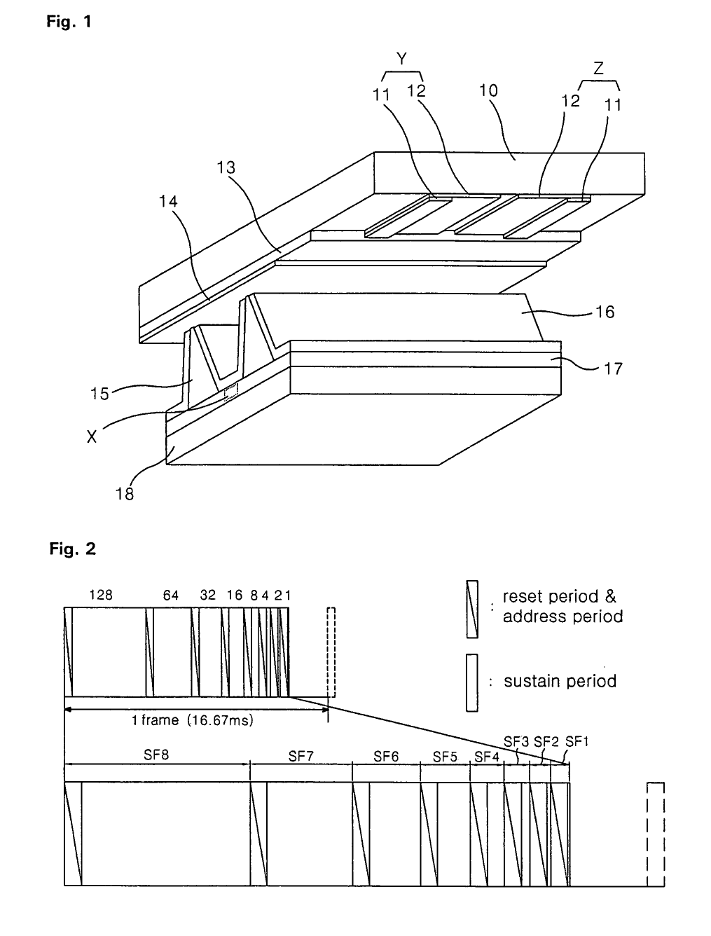

### DETAILED DESCRIPTION OF PREFERRED EMBODIMENTS

Preferred embodiments of the present invention will be described in a more detailed manner with reference to the drawings.

### First Embodiment

According to a first embodiment of the present invention, there is provided a plasma display panel including an upper substrate in which scan electrodes and sustain electrodes are formed, and a lower substrate in which address electrodes, horizontal diaphragms and vertical diaphragms are formed, wherein the horizontal diaphragms and the vertical diaphragms intersect one another to form a plurality of discharge cells, and the discharge cell comprises a main discharge cell on which phosphors are coated, and a sub discharge cell on which magnesium oxide is coated.

In the above, the horizontal diaphragm comprises a first horizontal diaphragm for separating the discharge cell and the discharge cell, and a second horizontal diaphragm for separating the main discharge cell and the sub discharge cell.

Further, an aperture portion for connecting the main discharge cell and the sub discharge cell is formed in the second horizontal diaphragm.

The scan electrode is formed on the first horizontal diaphragm.

The sustain electrode is formed on the second horizontal diaphragm.

A black matrix for improving contrast is formed on the sub discharge cell.

Phosphors are coated on the side of the sub discharge cell.

According to a first embodiment of the present invention, there is provided a method for driving a plasma display panel in which horizontal diaphragms and vertical diaphragms are intersected to form a plurality of discharge cells, including the steps of: allowing sub discharge cells on which magnesium oxide is coated within the discharge cells to generate a priming discharge; and allowing main discharge cells on which phosphors into which priming charged particles generated by the priming discharge are introduced are coated to generate an address discharge.

Furthermore, simultaneously when the main discharge cells generate the address discharge, the sub discharge cells separated by the horizontal diaphragms generate the priming discharge.

According to a first embodiment of the present invention, there is provided an apparatus for driving a plasma display panel in which horizontal diaphragms and vertical diaphragms are intersected to form a plurality of discharge cells, the horizontal diaphragms and the vertical diaphragms including: a plurality of discharge cells that are intersected one another, wherein the discharge cells are divided into main discharge cells on which phosphors are coated and sub discharge cells on which magnesium oxide is coated; and a driving circuit that generates a priming discharge within the sub discharge cells and generates an address discharge within the main discharge cells using priming charged particles generated by the priming discharge.

Moreover, the driving circuit includes a scan driving circuit for sequentially supplying a scan pulse to scan electrodes; a data drive circuit for supplying a data pulse synchronized to the scan pulse to address electrodes; and a sustain driving circuit that operates alternately with the scan driving circuit to supply a sustain pulse to sustain electrodes.

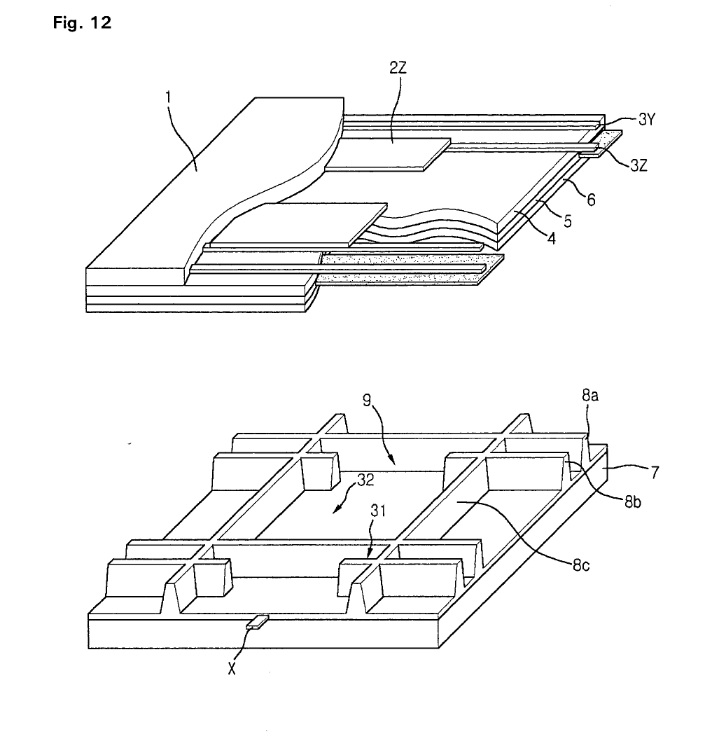

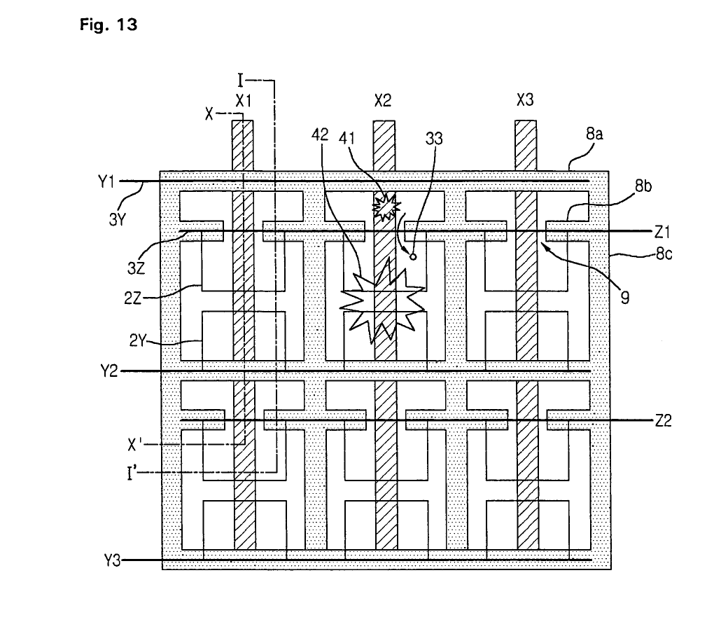

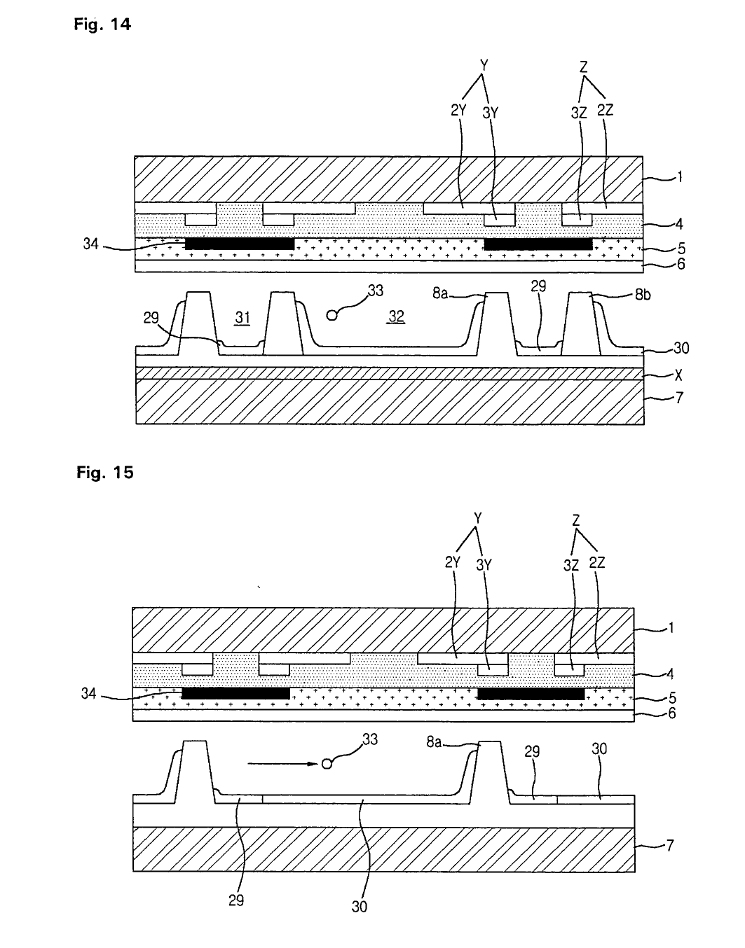

FIG. 12 shows a state where an upper plate and a lower plate of the PDP according to the present invention are separated. FIG. 13 is a view shown to explain an electrode and diaphragm structure of the PDP according to the present invention. FIG. 14 is a cross-sectional view illustrating a portion taken along lines I-I′ in FIG. 13. FIG. 15 is a cross-sectional view illustrating a portion taken along lines X-X′ in FIG. 13.

Referring to FIG. 12 to FIG. 15, a PDP according to a first embodiment of the present invention includes an upper substrate 1 having scan electrodes Y and sustain electrodes Z formed on its bottom, and a lower substrate 7 on which address electrodes X, horizontal diaphragms 8a and 8b, and vertical diaphragms 8c are formed. In the lower substrate 7, main discharge cells 32 and sub discharge cells 31 are formed by the horizontal diaphragms 8a and 8b and the vertical diaphragms 8c. The main discharge cell 32 has phosphors 30 coated thereon and the sub discharge cell 31 has magnesium oxide (MgO) 29 coated thereon. Although not shown in the drawings, the phosphors 30 may be coated on the sides of the sub discharge cells 31.

Furthermore, a mixed gas of He+Xe, Ne+Xe, He+Xe+Ne or the like is injected into discharge spaces formed by the upper substrate 1, the lower substrate 7, and the diaphragms 8a, 8b and 8c.

The phosphors 30 of red, green and blue are formed in the main discharge cell 32 and are excited with an ultraviolet light generated by the discharge to emit lights of red, green and blue wavelengths.

Moreover, the sub discharge cells 31 are adapted to generate priming charged particles 33 (charged particles and excited particles) so that the address discharge within the main discharge cell 32 is generated more rapidly. In the above, the magnesium oxide (MgO) 29 is a material that accelerates a discharge of the priming charged particles 33 and is coated on the sub discharge cells 31. The sub discharge cell 31 is a discharge space between the first horizontal diaphragm 8a and the second horizontal diaphragm 8b and serves to supply the priming charged particles 33 generated by the priming discharge to the main discharge cell 32.

The structure of the PDP will be described in more detail. The scan electrode Y is formed in the upper substrate 1 and includes a transparent electrode pattern 2Y of ITO (Indum Tin Oxide) that is located over the main discharge cell 32, and a metal bus electrode 3Y that is located over the first horizontal diaphragm 8a. Furthermore, the sustain electrode Z includes a transparent electrode pattern 2Z that is located corresponding to the transparent electrode pattern 2Y of the scan electrode Y, and a metal bus electrode 3Z that is located over the second horizontal diaphragm 8b.

The horizontal diaphragms 8a and 8b serve to separate the main discharge cells 32 and the sub discharge cells 31. More particularly, the first horizontal diaphragm 8a serves to separate the main discharge cell 32 and the sub discharge cell 31 both of which are adjacent up and down, thus preventing degradation of contract between the cells. The second horizontal diaphragm 8b has an aperture portion 9 formed therein so that the priming charged particles 33 moves to the main discharge cell 32. Also, the vertical diaphragm 8c is formed in the vertical direction to the horizontal diaphragms 8a and 8b and separates the main discharge cell 32 and the sub discharge cell 31 of red, green and blue that are arranged in the horizontal direction.

In addition, a black matrix 34 is formed in the upper substrate 1 over the sub discharge cell 31. The black matrix 34 is formed between a first dielectric layer 4 and a second dielectric layer 5. A protect layer 6 made of magnesium oxide (MgO) is formed in front of the second dielectric layer 5.

The black matrix 34 serves to prevent lights generated when a discharge occurs between the metal bus electrode 3Y of the scan electrode Y and the metal bus electrode 3Z of the sustain electrode Z within the sub discharge cell 31 from leaking outside, thus preventing degradation of contrast.

Hereinafter, the operation of the PDP constructed above according to the present invention will be described through a method and apparatus for driving a PDP.

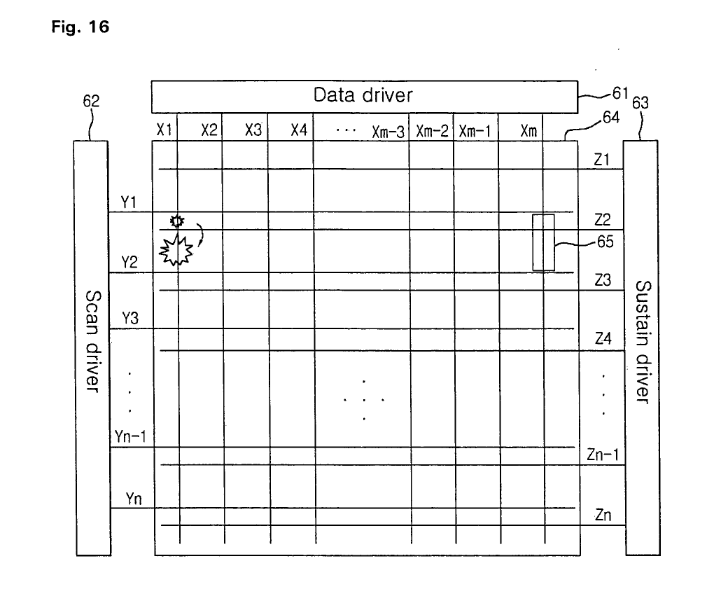

FIG. 16 shows an apparatus for driving a plasma display panel according to the present invention.

Referring to FIG. 16, the apparatus for driving the PDP 64 according to the present invention includes a data driver 61 for supplying video data to address electrodes X1 to Xm, a scan driver 62 for supplying an initialization signal, a scan pulse and a sustain pulse to scan electrodes Y1 to Yn, and a sustain driver 63 for supplying a sustain pulse to sustain electrodes Z1 to Zn.

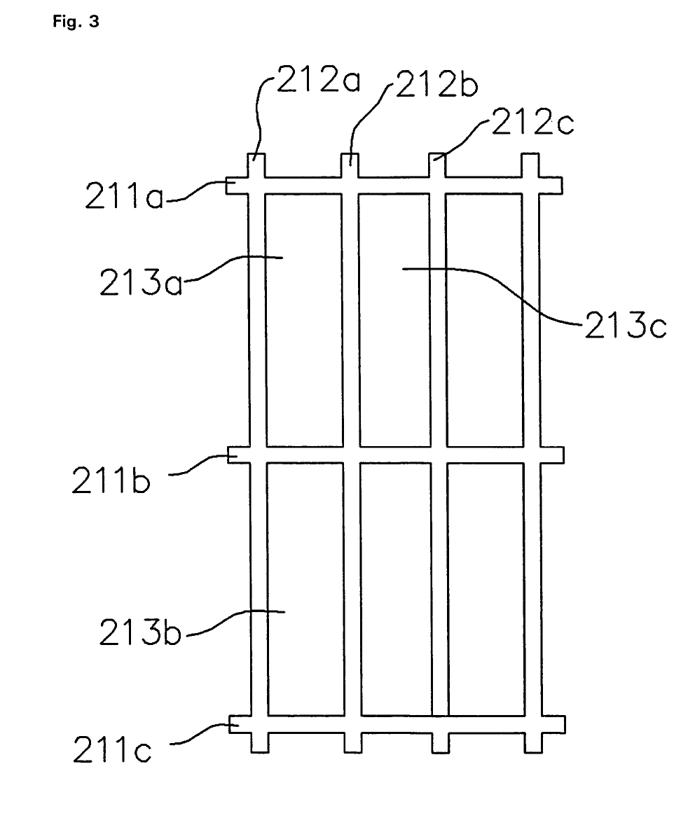

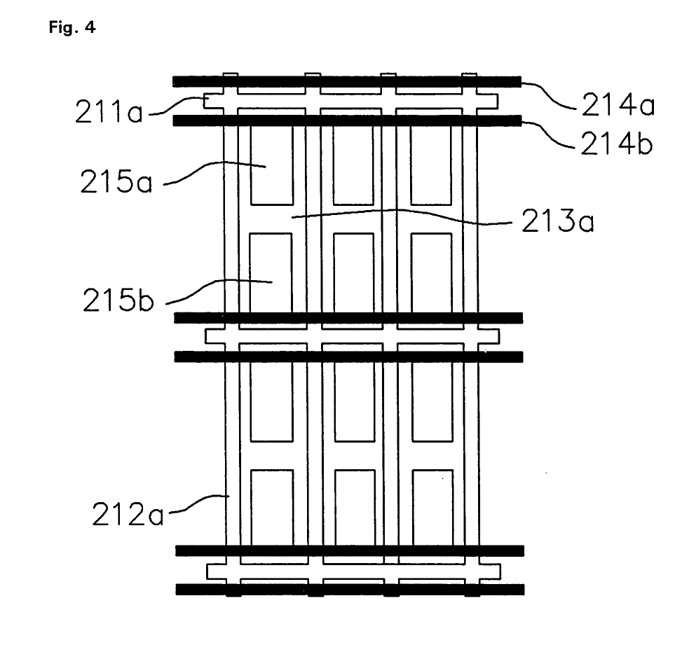

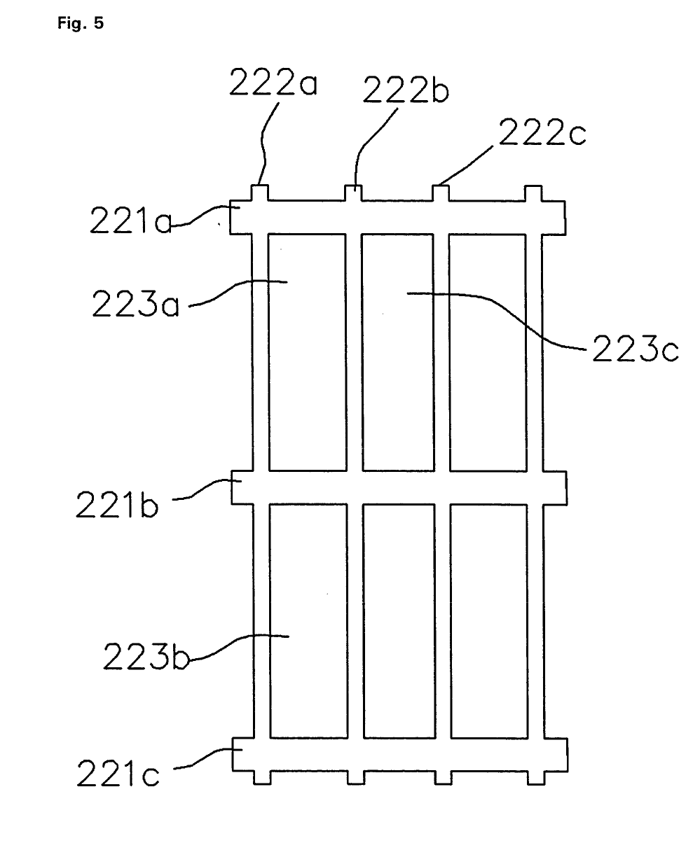

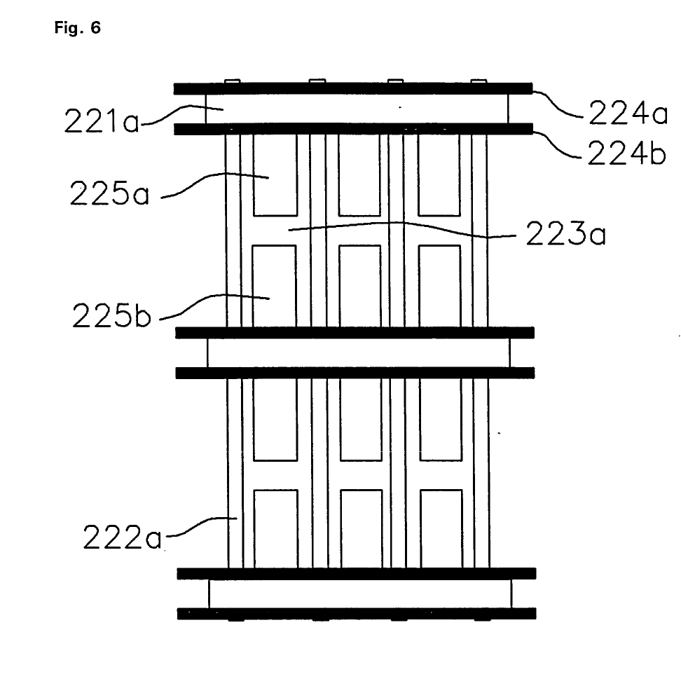

The scan electrodes Y1 to Yn and the sustain electrodes Z1 to Zn intersect the address electrodes X1 to Xm. Cells 65 are arranged at the intersections in a matrix shape. Each of the cells 65 includes the main discharge cell 32 on which the phosphors 30 are formed, and the sub discharge cell 31 on which the magnesium oxide 29 are formed, as described in FIGS. 3 to 6.

The data driver 61 serves to supply the video data to the address electrodes X1 to Xm so that the data are synchronized to scan pulses that are sequentially supplied to the scan electrodes Y1 to Yn. The scan driver 62 functions to supply a ramp-up waveform and a ramp-down waveform for initializing the whole screen to the scan electrodes Y1 to Yn during a reset period. In addition, the scan driver 62 sequentially supplies the scan pulse to the scan electrodes Y1 to Yn during an address period and then supplies the sustain pulse to the scan electrodes Y1 to Yn during a sustain period.

Moreover, the sustain driver 63 supplies a DC bias voltage of the positive polarity to the sustain electrodes Z1 to Zn during some of the reset period and during the address period. The sustain driver 63 then alternately operates together with the scan driver 62 during the sustain period to supply the sustain pulse to the sustain electrodes Z1 to Zn. Next, the sustain driver 63 supplies an erase signal for erasing the remaining charges within the cell 65 to the sustain electrodes Z1 to Zn.

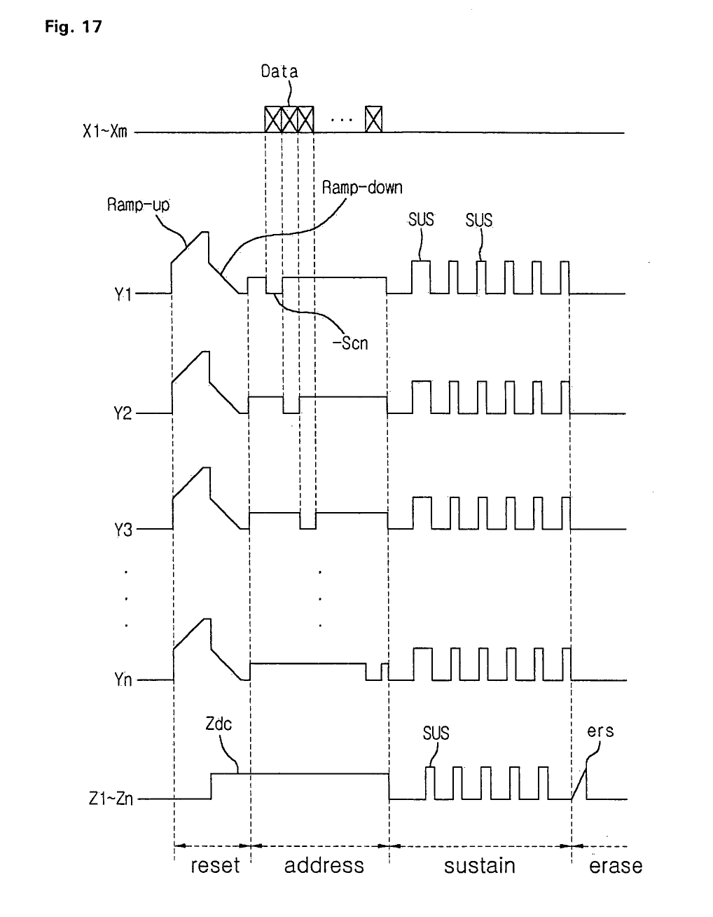

FIG. 17 shows a method for driving the PDP according to the present invention.

Referring to FIG. 17, during the reset period, the ramp-up waveform ramp-up and the ramp-down waveform ramp-down are applied to the scan electrodes Y1 to Yn at the same time. A weak discharge is generated within cells of the whole screen by means of the ramp-up waveform. As a result, wall charges are generated within the cells of the whole screen. Meanwhile, the ramp-down waveform causes a weak erase discharge to occur in the cells, thus erasing charges unnecessary for the address discharge among the wall charges generated by the ramp-up waveform and spatial charges. Therefore, the wall charges uniformly remain within the cells of the whole screen.

During the address period, a scan pulse scan of the negative polarity is sequentially applied to the scan electrodes Y1 to Yn. At the same time, a data pulse data of the positive polarity is applied to the address electrodes X1 to Xm so that it is synchronized to the scan pulse scan.

At this time, an address discharge occurs between the scan electrodes Y1 to Yn and the address electrodes X1 to Xm within the main discharge cell 32 due to a difference in voltage between the scan pulse-scan and the data pulse data. At the same time, a weak priming discharge occurs between the scan electrodes Y1 to Yn and the sustain electrodes Z2 to Zn. Therefore, the priming charged particles 33 generated by the priming discharge are moved toward the main discharge cell 31 through the aperture portion 9 of the second horizontal diaphragm 8b.

Thereafter, if the scan pulse scan is generated, the difference in voltage between the scan pulse-scan and the data pulse data and the wall voltage generated during the reset period are added. As the voltage and a priming effect by the priming charged particles 33 are added, an address discharge is generated between the scan electrodes Y1 to Yn and the address electrodes X1 to Xm in the main discharge cell 32.

Wall charges of the positive polarity are accumulated on the scan electrodes Y1 to Yn and wall charges of the negative polarity are accumulated on the address electrodes X1 to Xm in an on-cell selected by the address discharge. Further, distribution of the wall charges on the sustain electrodes Z1 to Zn almost keeps a wall charge state right after the reset period.

The priming discharge of the sub discharge cell 31 on which the magnesium oxide 29 is coated will now be described through the address discharge process. If the scan pulse scan is applied to the first scan electrode Y1, a priming discharge (41 in FIG. 13) occurs between the first scan electrode Y1 and the second scan electrode Z2 within the sub discharge cell 31 in a second line. Next, if the scan pulse scan is applied to the second scan electrode Y2, an address discharge (42 in FIG. 13) is generated between the second scan electrode Y2 and the address electrodes X1 to Xm within the main discharge cell 32 in the second line with the help of the priming effect by the priming discharge.

The address discharge is easily generated within short time by means of the priming discharge generated in the sub discharge cell 31 and the priming effect due to it. Resultantly, a jitter value that is generated when the amount of Xe is increased in a discharge gas of the PDP is increased, i.e., delay of the address discharge is minimized.

Meanwhile, during the period where the ramp-down waveform is supplied and during the address period, a DC voltage Zdc of the positive polarity is applied to the sustain electrodes Z1 to Zn.

Moreover, during the sustain period, a sustain pulse sus is alternately applied to the scan electrodes Y1 to Yn and the sustain electrodes Z1 to Zn. In an on-cell selected by the address discharge, whenever the sustain pulse sus is applied, a sustain discharge having a surface discharge shape is generated between the scan electrodes Y1 to Yn and the sustain electrodes Z1 to Zn as the wall voltage in the cell and the voltage of the sustain pulse sus are added.

Also, during the erase period after the sustain period, an erase signal ers of a ramp waveform shape for erasing the remaining charges within the cell, which are generated by the sustain discharge, is supplied.

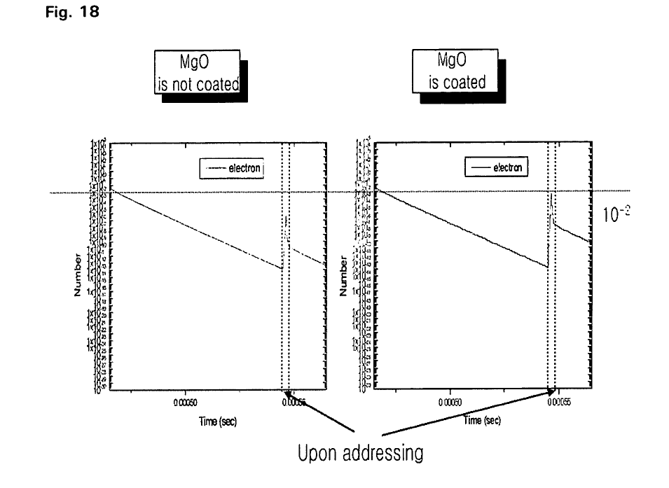

FIG. 18 is a graph illustrating the number of ions in case where magnesium oxide is coated and not coated on the sub discharge cell.

From FIG. 18, it can be seen that more charged particles are generated by coating magnesium oxide (MgO) in the sub discharge cell, thus causing the address discharge to occur rapidly.

As described above, according to the first embodiment of the present invention, the first horizontal diaphragm and the second horizontal diaphragm are provided to form the main discharge cell and the sub discharge cell. After the priming discharge is generated in the sub discharge cell on which magnesium oxide is coated, the address discharge is generated. Therefore, the address discharge can occur rapidly.

### Second Embodiment

According to a second embodiment of the present invention, a surface discharge type AC type plasma display panel including horizontal diaphragms and vertical diaphragms that are formed on a lower substrate to separate respective cells, and bus electrodes formed under an upper substrate, wherein the plasma display panel has a diaphragm structure in which the horizontal diaphragms are thicker in width than the vertical diaphragms, wherein horizontal grooves having a predetermined width and height are formed in the horizontal diaphragms that separate upper cells and lower cells adjacent in the horizontal direction, and when the upper substrate and the lower substrate are combined, bus electrodes are disposed right on the horizontal grooves in the horizontal direction.

Furthermore, sustain bus electrodes among the bus electrodes disposed right on the horizontal grooves are integrated into one, so that a voltage is applied to the upper cell and the lower cell at the same time.

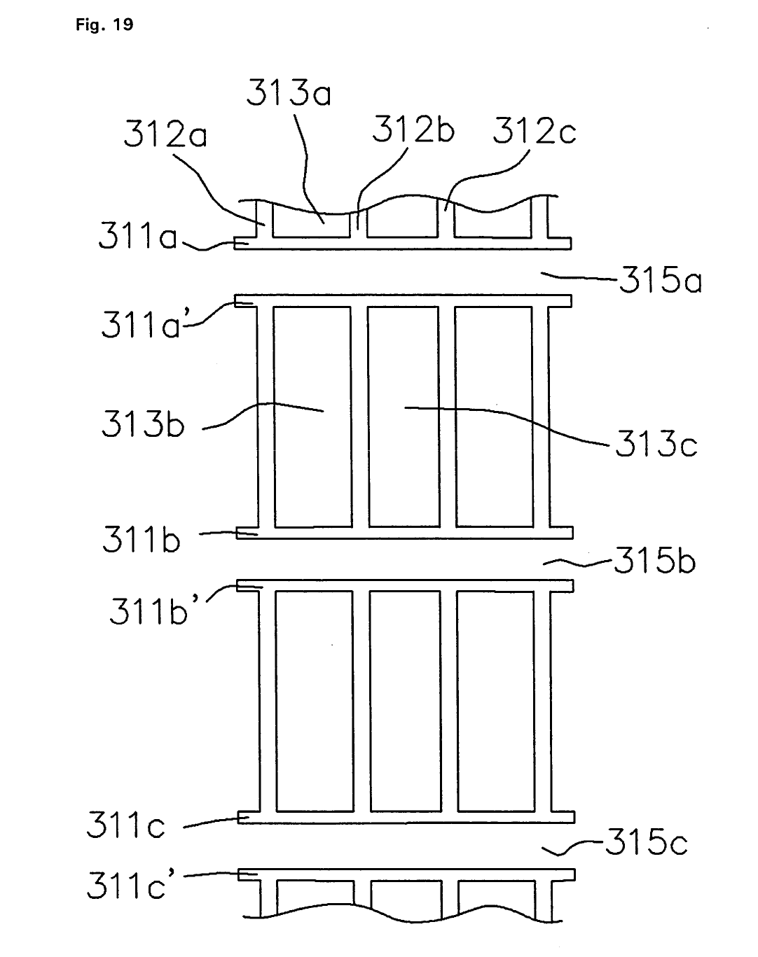

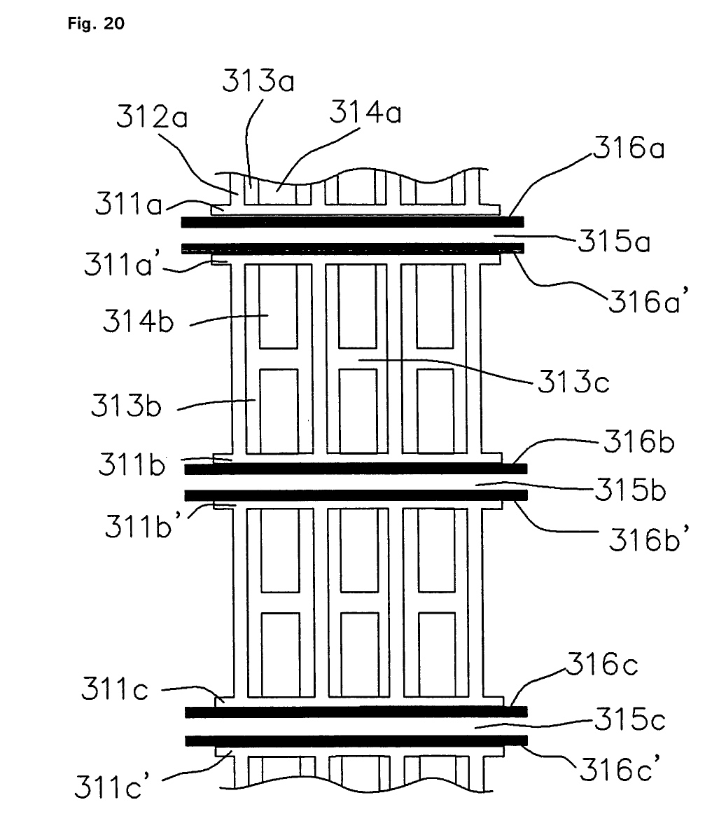

FIG. 19 is a plane view illustrating a well type diaphragm structure of a surface discharge type AC PDP according to a second embodiment of the present invention. FIG. 20 is a plane view illustrating a state where the bus electrodes are disposed immediately on the horizontal grooves while including the diaphragm structure of FIG. 19.

Referring to FIG. 19, respective cells 313a, 313b and 313c are separated by horizontal diaphragm 311a, 311a′, 311b, 311b′, 311c and 311c′, and the vertical diaphragm 312a, 312b and 312c. The horizontal diaphragms have a width thicker than the vertical diaphragms. Horizontal grooves 315a, 315b and 315c having a given width and height are formed in the horizontal diaphragms in the horizontal direction.

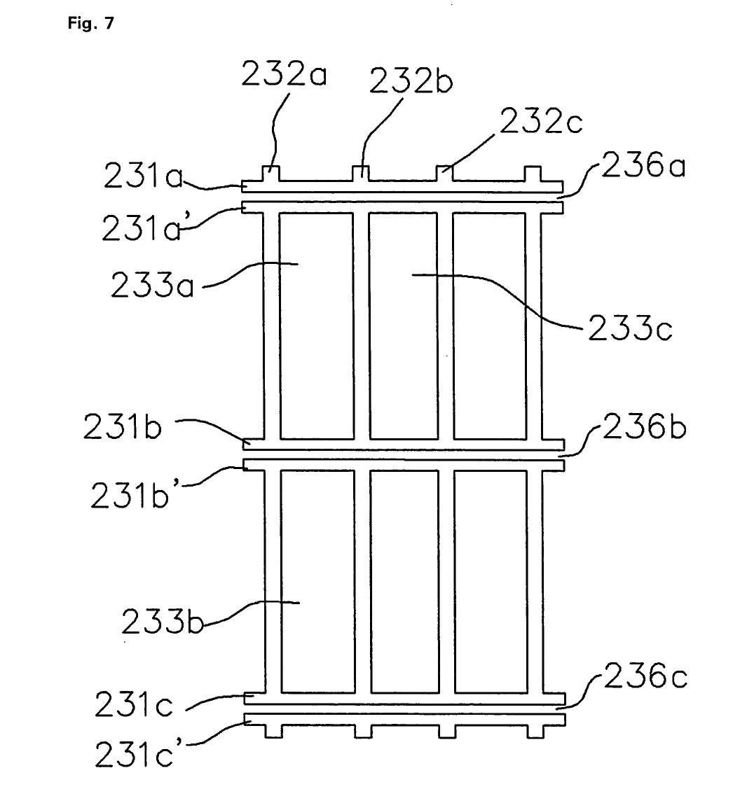

In the PDP according to the present invention, the horizontal diaphragm is formed thickly as described above. It is thus possible to increase brightness and efficiency compared to the conventional PDP (see FIG. 3 to FIG. 8). It is also possible to reduce capacitance between the upper electrode and the lower electrode by forming the horizontal grooves 315a, 315b and 315c.

As shown in FIG. 20, bus electrodes 316a and 316b are formed right on the horizontal groove 315a and are also formed in the horizontal direction at both edges of the grooves. That is, the bus electrodes 315a, 315b and 315c are located on the horizontal diaphragm in a prior art, but are located right on the horizontal groove 315a in this embodiment. Unexplained reference numerals 314a and 314b indicate ITO electrodes.

The PDP in which the bus electrodes 316a and 316b are disposed right on the horizontal groove 315a as above has capacitance between the upper electrode and the lower electrode, which is lower than the PDP in which the bus electrode is disposed on the horizontal diaphragm (see FIG. 3 to FIG. 8). This is because if the bus electrodes are disposed right on the horizontal grooves, given spaces are formed between the data electrodes and the upper electrodes. If capacitance reduces as above, invalid power also reduces. Thus, power consumption of a PDP product itself also reduces.

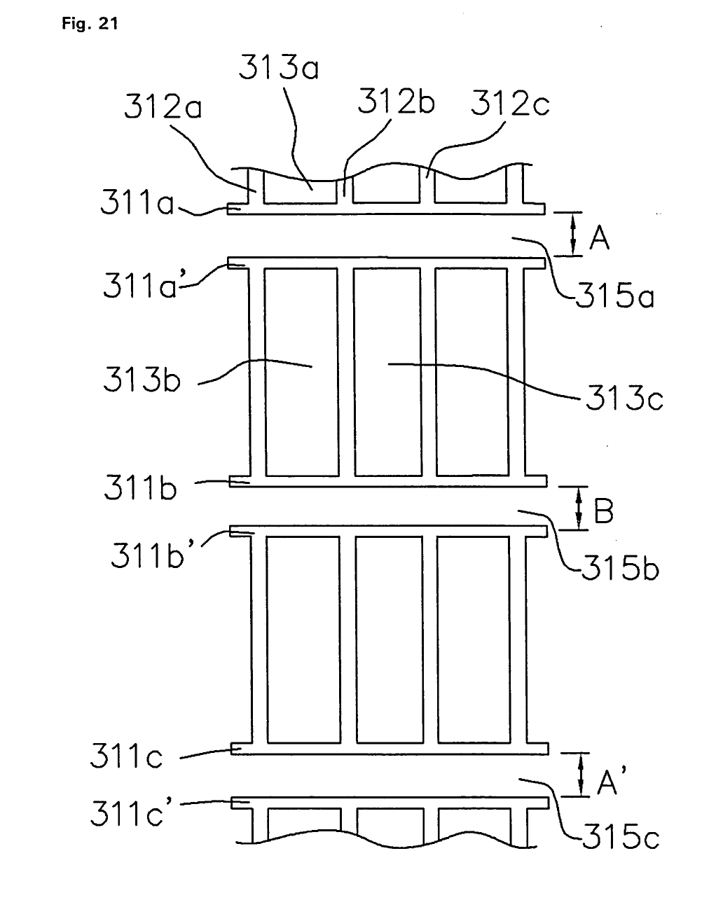

Electrodes formed in the upper plate include bus electrodes, ITO electrodes, etc. Electrodes formed in the lower plate include address electrodes. The bus electrode includes a sustain bus electrode and a scan bus electrode. FIG. 21 to FIG. 24 show that the bus electrodes (the sustain bus electrodes and the scan bus electrodes) are disposed right on the horizontal grooves.

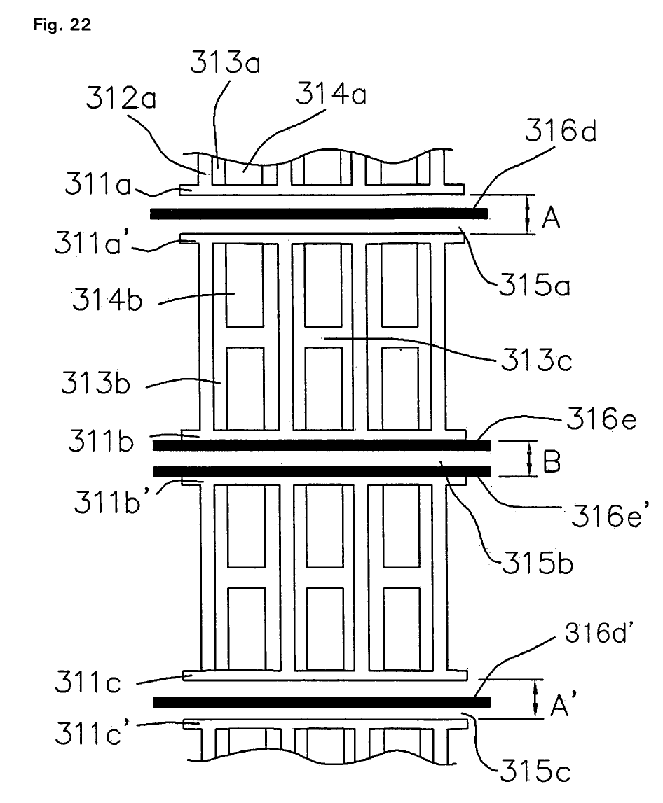

FIG. 21 is a plane view illustrating a well type diaphragm structure of a surface discharge type AC plasma display panel according to a variation of the second embodiment of the present invention. FIG. 22 is a plane view illustrating a state where bus electrodes are disposed right on horizontal grooves while including the diaphragm structure of FIG. 22. The diaphragm structure of FIG. 21 is the same as the diaphragm structure of FIG. 19. Therefore, description on the diaphragm structure of FIG. 21 will not be given in order to avoid redundancy.

Referring to FIG. 22, bus electrodes are formed right on the horizontal grooves. Sustain bus electrodes 316d and 316d′ among the bus electrodes are placed on horizontal grooves (hereinafter, referred to as a “sustain groove”) 315a and 315c in the top and bottom stages, respectively. Scan bus electrodes 316e and 316e′ are disposed on horizontal grooves (hereinafter, referred to as a “scan groove”) 315b in the middle stage. It is to be noted that the position of the sustain bus electrode and the scan bus electrode is not specially limited. In other words, the scan bus electrode can be located in the top and bottom stages and the sustain bus electrode can be located in the middle stage. Unexplained reference numerals A and A′ designate a width of the sustain groove and B indicates a width of the scan groove.

The scan bus electrodes 316e and 316e′ are formed at the same location as the bus electrode shown in FIG. 19 or FIG. 20. That is, the scan bus electrodes 316e and 316e′ are disposed on both edges of the horizontal groove 315b in the horizontal direction.

The sustain bus electrodes 316d and 316d′ are integrated into one and are disposed at the centers of the horizontal grooves 315a and 315c, respectively, and apply the sustain voltage to an upper cell 314a and a lower cell 314b, which are adjacent each other, at the same time. If two sustain bus electrodes are integrated into one as above, the structure of a plasma display panel is simplified compared to a plasma display panel having the diaphragm structure as shown in FIG. 19 or FIG. 20. Further, capacitance between upper electrodes and lower electrodes can be further reduced.

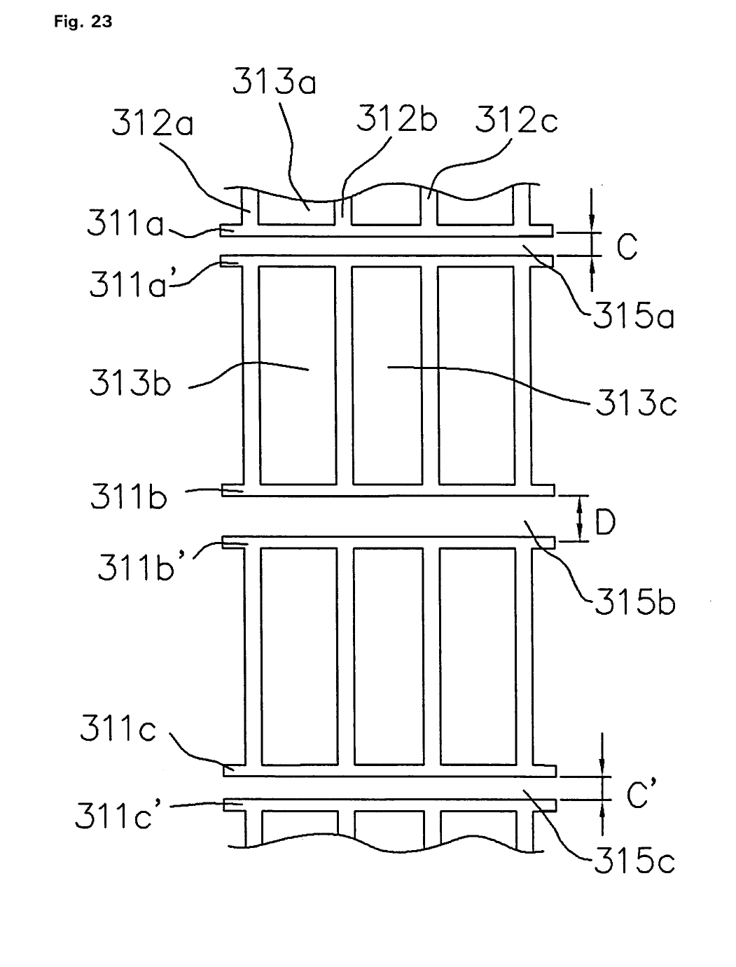

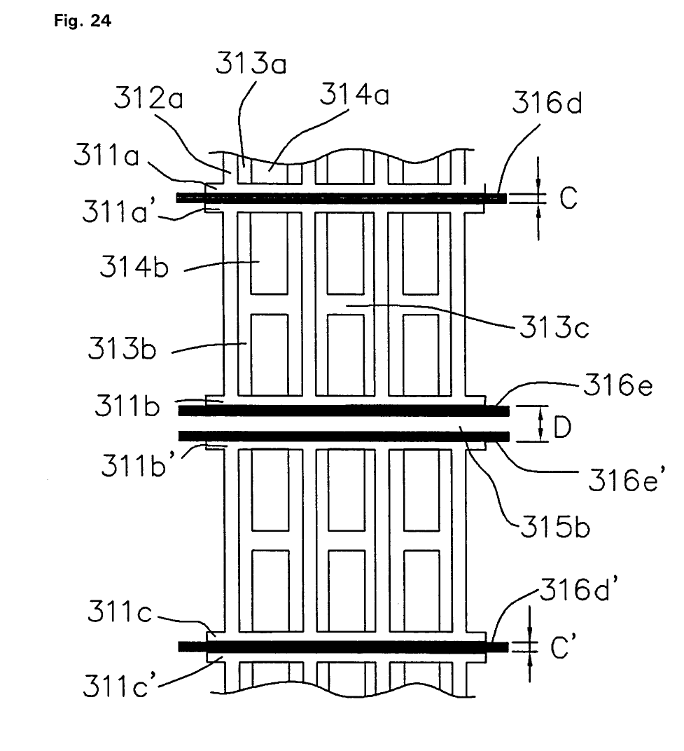

FIG. 23 is a plane view illustrating a well type diaphragm structure of a surface discharge type AC plasma display panel according to another variation of the second embodiment of the present invention. FIG. 24 is a plane view illustrating a state where the bus electrodes are disposed right on the horizontal grooves while including the diaphragm structure of FIG. 23.

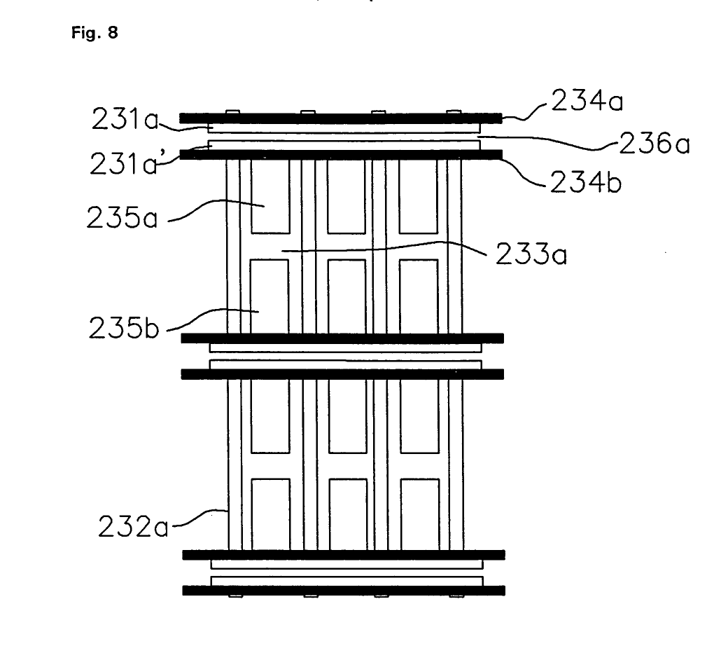

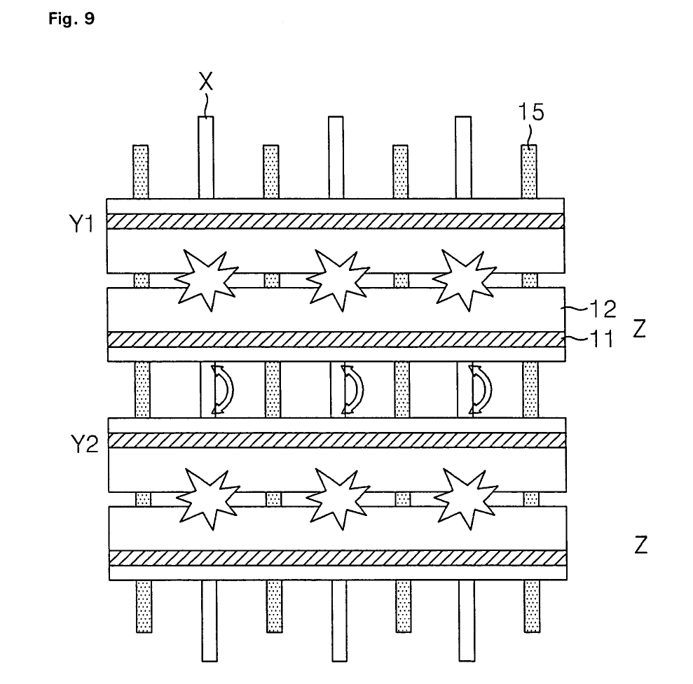

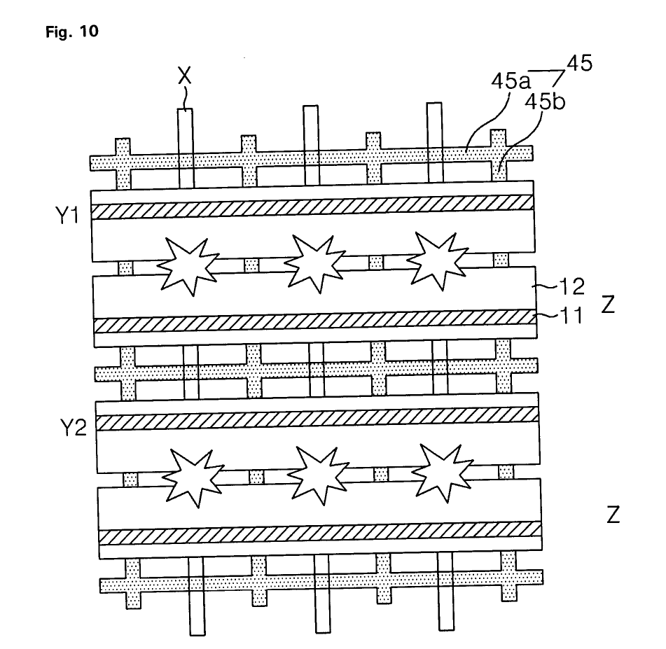

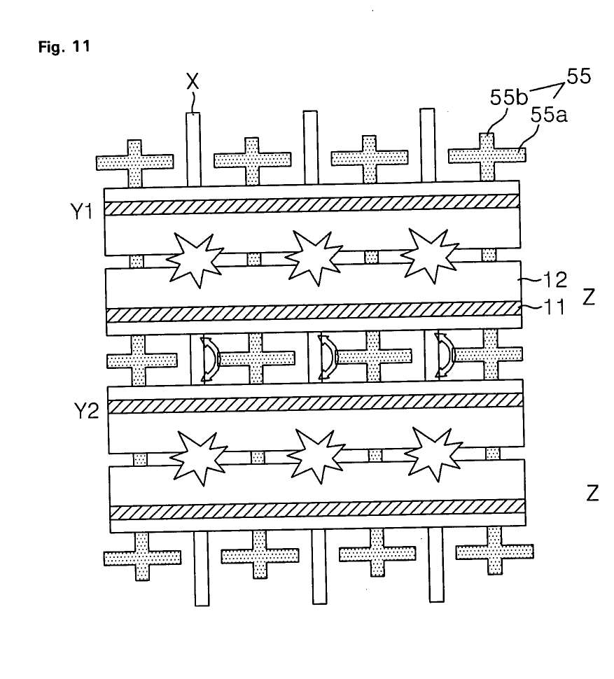

The diaphragm shown in FIG. 23 will be described in comparison with the diaphragm shown in FIG. 21. The diaphragm has a structure in which widths C and C′ of sustain grooves are shortened. This is for minimizing gaps between the sustain grooves C and C′ where the sustain bus electrodes 316d and 316d′ are located, as shown in FIG. 8b. By minimizing the widths C and C′ of the sustain grooves as above, it is possible to minimize the size of the discharge cell.

As described above, according to the second embodiment of the present invention, in the well type diaphragm of the surface discharge type AC type PDP, the horizontal diaphragm is divided into two sections. It is thus possible to reduce capacitance between the upper plate and the lower plate. More particularly, as the sustain bus electrodes are integrated into one and the sustain bus electrodes are disposed on the sustain grooves, it is possible to further reduce capacitance. Invalid power can be thus minimized. Furthermore, by minimizing the sustain grooves, the size of a discharge cell can be further miniaturized compared to a prior art.

### Third Embodiment

According to a third embodiment of the present invention, there is provided a plasma display panel, including: a main discharge cell; a sub discharge cell adjacent to the main discharge cell; a diaphragm having a plurality of horizontal diaphragms that separates the main discharge cell and the sub discharge cell, and a plurality of vertical diaphragms connected to the horizontal diaphragms; and an exhaust/charge passage that penetrates the horizontal diaphragms, for guiding charged particles generated from the sub discharge cell to the main discharge cell.

The PDP according to the third embodiment of the present invention further includes upper electrodes formed on an upper substrate to generate a discharge in the main discharge cell and the sub discharge cell, phosphors formed on the horizontal diaphragms and the vertical diaphragms, and lower electrodes formed on a lower substrate that is opposite to the upper substrate in the direction that the lower electrodes intersect the upper electrodes.

Each of the upper electrodes includes a transparent electrode, and a metal bus electrode formed at one side of the transparent electrode.

A method for driving a PDP according to a third embodiment of the present invention, wherein the PDP includes a main discharge cell, a sub discharge cell adjacent to the main discharge cell, a diaphragm having a plurality of horizontal diaphragms that separates the main discharge cell and the sub discharge cell, and a plurality of vertical diaphragms connected to the horizontal diaphragms, and an exhaust/charge passage that penetrates the horizontal diaphragms, for guiding charged particles generated from the sub discharge cell to the main discharge cell, the method includes the step of causing a discharge to occur in the main discharge cell using priming charged particles generated from the sub discharge cell.

An apparatus for driving a plasma display panel according to a third embodiment of the present invention, wherein the plasma display panel including a main discharge cell, a sub discharge cell adjacent to the main discharge cell, a diaphragm having a plurality of horizontal diaphragms that separates the main discharge cell and the sub discharge cell, and a plurality of vertical diaphragms connected to the horizontal diaphragms, and an exhaust/charge passage that penetrates the horizontal diaphragms, for guiding charged particles generated from the sub discharge cell to the main discharge cell, the apparatus includes a driving unit for causing a discharge to occur in the main discharge cell using priming charged particles generated from the sub discharge cell.

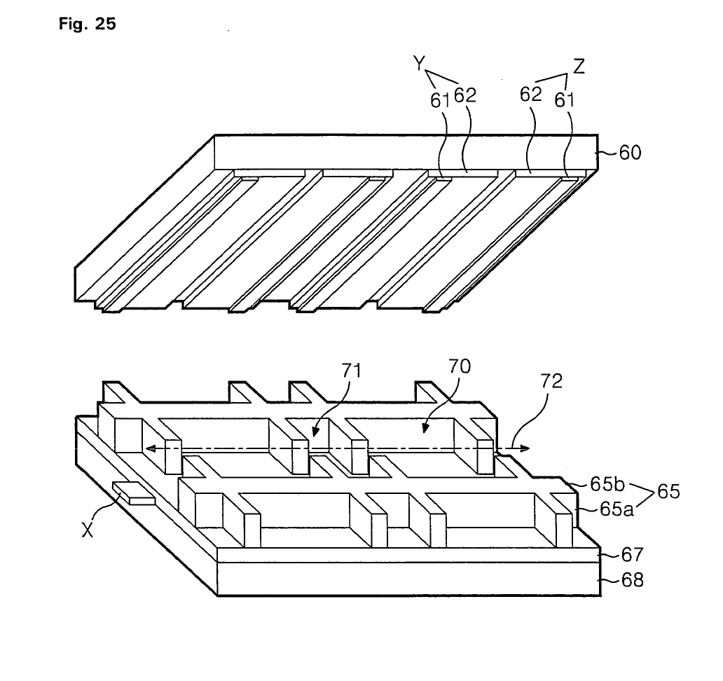

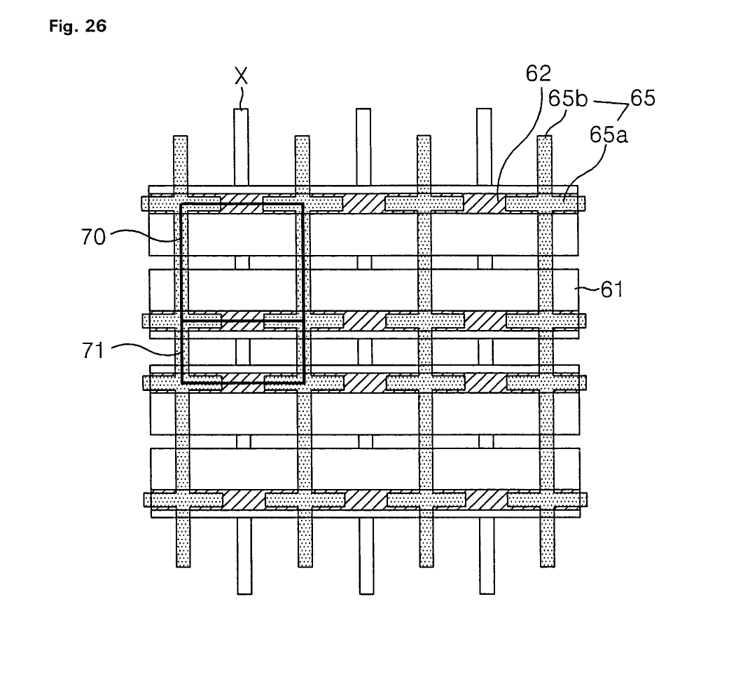

FIG. 25 is a dismantled perspective view illustrating a plasma display panel according to a third embodiment of the present invention, and FIG. 26 is a plane view illustrating the arrangement of electrodes and the diaphragm of the PDP shown in FIG. 25.

Referring to FIGS. 25 and 26, the PDP according to an embodiment of the present invention includes a main discharge cell 70 where effective display is made, a sub discharge cell 71 for supplying priming charged particles to the main discharge cell 70, and an exhaust/charge passage 72 that penetrates the main discharge cell 70 and the sub discharge cell 71.

The main discharge cell 70 and the sub discharge cell 71 are separated by a diaphragm 65 having a horizontal diaphragm 65a and a vertical diaphragm 65b. Phosphors (not shown) that are excited and shifted by ultraviolet generated upon plasma discharge to generate a visible ray are formed in the main discharge cell 70. The sub discharge cell 71 generates charged particles upon the plasma discharge. The charged particles generated from the sub discharge cell 71 are priming charged particles that facilitate a plasma discharge within the main discharge cell 70 and are supplied to the main discharge cell 70. An inert gas in which He, Xe, Ne, Kr, Ar, etc. are mixed is injected into the main discharge cell 70 and the sub discharge cell 71.

On an upper substrate 60 of the PDP are formed a plurality of scan electrodes Y and a plurality of sustain electrodes Z. Address electrodes X that intersect the scan electrodes Y and the sustain electrodes Z are formed on a lower substrate 68.

Each of the scan electrode Y and the sustain electrode Z includes a transparent electrode 62, and a metal bus electrode 61 that has a line width narrower than the transparent electrode 62 and is formed at one edge of the transparent electrode 62. The transparent electrode 62 is formed on the upper substrate 60 using a transparent conductive metal material such as ITO. The metal bus electrode 61 is formed at one side of the transparent electrode 62 using a metal of low electrical resistance and serves to reduce a voltage drop by the transparent electrode 62 of high resistance.

A dielectric layer (not shown) for covering the scan electrodes Y and the sustain electrodes Z is formed on the upper substrate 60. A MgO protect film (not shown) is formed on the dielectric layer.

The diaphragm 65 is formed on the lower substrate 68. The horizontal diaphragm 65a of the diaphragm 65 is formed in the horizontal direction of the discharge cell as much as the length smaller than a ½ horizontal width of the discharge cell from the vertical diaphragm 65b. The horizontal diaphragm 65a is located on a boundary line between the main discharge cell 70 and the sub discharge cell 71 that are adjacent each other in the horizontal direction and is overlapped with the metal bus electrode 61 of the scan electrode Y and the sustain electrode Z. An exhaust/charge passage 72 is formed between the horizontal diaphragms 65a that are opposite each other.

The vertical diaphragm 65b is formed along the address electrode X with the address electrode X intervened between them. The vertical diaphragm 65b is located on the boundary line between the main discharge cells 70 and the sub discharge cells 71 that are adjacent each other.

In the PDP according to the present invention, the metal bus electrode 61 is overlapped with the horizontal diaphragm 65a. Thus, there is no decrease in the aperture ratio due to the metal bus electrode 61 in the main discharge cell 70. Also, in the PDP according to the present invention, a vertical discharge space of the main discharge cell can be reduced as much as the sub discharge cell compared to a conventional PDP, but emission efficiency is increased. This is because emission efficiency is not significantly changed if the vertical discharge space of the discharge cell increases and emission efficiency of phosphors is improved since the phosphors formed in the horizontal diaphragm 65b closely approach the discharge space where a discharge is significantly increased.

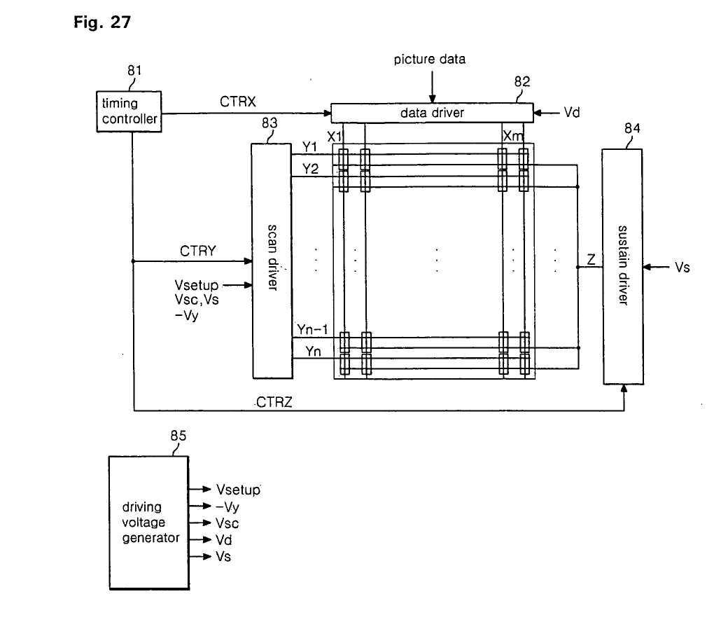

FIG. 27 shows a plasma display panel and an apparatus for driving the PDP according to a third embodiment of the present invention.

Referring to FIG. 27, the apparatus for driving the PDP according to the present invention includes a data driver 82 for supplying data to address electrodes X1 to Xm of a PDP, a scan driver 83 for driving scan electrodes Y1 to Yn, a sustain driver 84 for driving sustain electrodes Z, a timing controller 81 for controlling the respective drivers 82, 83 and 84, and a driving voltage generator 85 for generating driving voltages necessary for the respective drivers 82, 83 and 84.

The data driver 82 samples and latches data in response to a timing control signal CTRX generated from the timing controller 81 and supplies the data to the address electrodes X1 to Xm.

The scan driver 83 supplies an initialization waveform to the scan electrodes Y1 to Yn under the control of the timing controller 81 during a reset period. The scan driver 83 sequentially supplies a scan pulse to the scan electrodes Y1 to Yn during an address period, supplies a sustain pulse sus to the scan electrodes Y1 to Yn during a sustain period and supplies an erase signal to the scan electrodes Y1 to Yn after the sustain discharge is finished.

The sustain driver 84 alternately operates together with the scan driver 83 under the control of the timing controller 81 to supply the sustain pulse sus to the sustain electrodes Z.

The timing controller 81 receives a vertical/horizontal synchronization signal and a clock signal and generates timing control signals CTRX, CTRY and CTRZ necessary for the respective drivers. Furthermore, the timing controller 81 controls the respective drivers 82, 83 and 84 by supplying the timing control signals CTRX, CTRY and CTRZ to corresponding drivers 82, 83 and 84. The data control signal CTRX includes a sampling clock for sampling data, a latch control signal, and a switch control signal for controlling an on/off time of an energy recovery circuit and a driving switch device. The scan control signal CTRY includes a switch control signal for controlling an on/off time of an energy recovery circuit and a driving switch device within the scan driver 83. Further, the sustain control signal CTRZ includes a switch control signal for controlling an on/off time of an energy recovery circuit and a driving switch device within the sustain driver 84.

The driving voltage generator 85 generates a setup voltage Vsetup of the initialization waveform, a scan voltage—Vy, a scan swing voltage Vsc, a sustain voltage Vs, a data voltage Vd and the like. These driving voltages may be changed depending on composition of a discharge gas or the structure of a discharge cell.

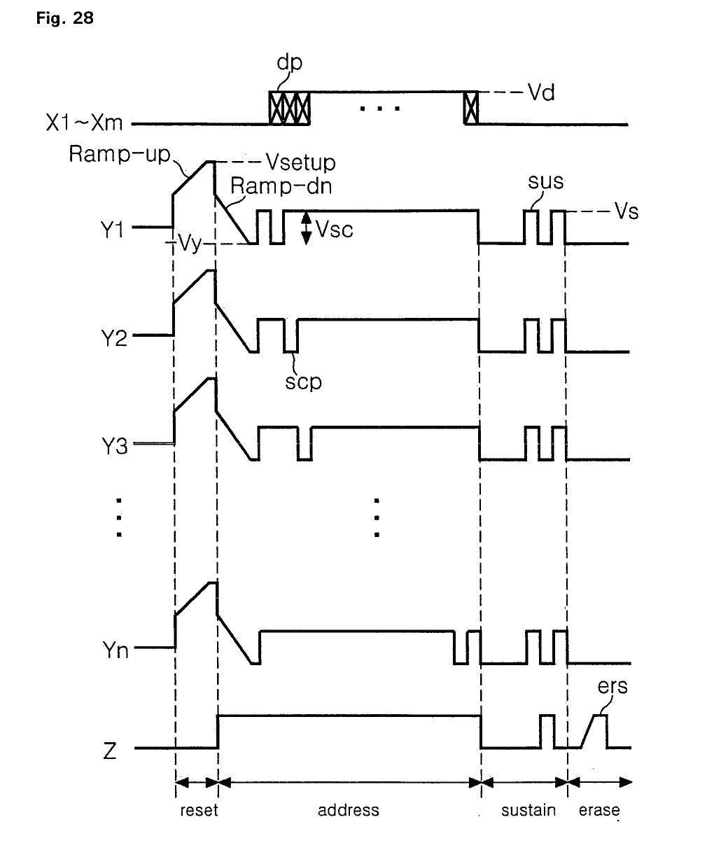

FIG. 28 shows a driving waveform of a plasma display panel according to a third embodiment of the present invention PDP, which is generated from the driving apparatus shown in FIG. 27.

Referring to FIG. 28, after a ramp-up waveform Ramp-up is supplied to all the scan electrodes Y as an initialization waveform during the reset period, a ramp-down waveform Ramp-dn is supplied. A setup discharge is generated as a weak discharge between the scan electrode Y and the address electrode X and between the scan electrode Y and the sustain electrode Z within cells of the whole screen by means of the ramp-up waveform Ramp-up. Wall charges of the positive polarity (+) are accumulated on the address electrodes X and the sustain electrodes Z by means of the setup discharge. Wall charges of the negative polarity (−) are accumulated on the scan electrodes Y. While the ramp-down waveform Ramp-dn is supplied to the scan electrodes Y, the sustain voltage Vs of the positive polarity is supplied to the sustain electrodes Z and O V is supplied to the address electrodes X. When the ramp-down waveform Ramp-dn is supplied as such, a set-down discharge occurs as a weak discharge between the scan electrodes Y and the sustain electrodes Z and between the scan electrodes Y and the address electrodes X.

Redundant wall charges unnecessary for the address discharge among the wall charges, which are formed upon the setup discharge, are erased by the set-down discharge. Variation in the wall charges in this reset period will now be described. There almost no variation in the wall charges on the address electrodes X. Some of the wall charges of the negative polarity (−) on the scan electrodes Y, which are formed upon the setup discharge, are reduced by the set-down discharge. On the contrary, although the wall charges of the positive polarity are formed on the sustain electrodes Z upon the setup discharge, wall charges of the negative polarity are accumulated on the sustain electrodes Z as much as the amount that the wall charges of the negative polarity of the scan electrode Y are reduced upon the set-down discharge as the wall charges of the negative polarity are accumulated.

During an address period, a scan pulse scp having a swing width of a scan swing voltage Vsc wherein the voltage of the scan pulse is lowered to a scan voltage—Vy of the negative polarity is sequentially applied to the scan electrodes Y. At the same time, a data pulse of a data voltage Vd of the positive polarity that is synchronized to the scan pulse scp is supplied to the address electrodes X. While a difference in voltage between the scan pulse scp and the data pulse and a wall voltage generated in the reset period are added, an address discharge is generated in the main discharge cell 70 to which the data pulse is supplied. Wall charges of the degree that may generate a discharge when the sustain voltage Vs is supplied are formed within the main discharge cells 70 selected by the address discharge.

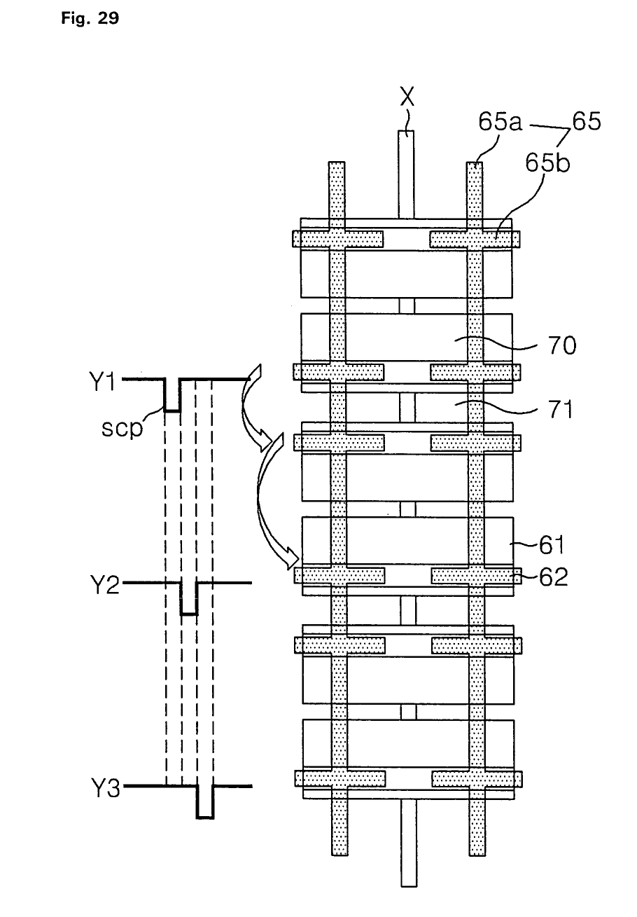

FIG. 29 is a plane view illustrating movement of priming charged particles that are generated from a sub discharge cell. Simultaneously with the address discharge, an assistant discharge occurs between the scan electrode Y and the address electrode X and/or between the scan electrode Y and the sustain electrode Z within the sub discharge cell 71, as shown in FIG. 29. Priming charged particles generated by the assistant discharge are supplied to the main discharge cells 70 through the exhaust/charge passage 72. If the scan pulse scp and the data pulse are applied to a main discharge cell of a next scan line by means of the priming charged particles generated from the sub discharge cell included in a previous scan line as such, the wall voltage within the cell is increased due to the priming charged particles. Thus, an address discharge occurs rapidly and safely. Therefore, in the method and apparatus for driving the PDP according to the present invention, high-speed driving is possible because the address period is reduced.

During a sustain period, the sustain pulse sus of the sustain voltage Vs is alternately supplied to the scan electrodes Y and the sustain electrodes Z. In the main discharge cell 70 selected by the address discharge, as the wall voltage and an external sustain voltage Vs within the cell are added, a sustain discharge, i.e., a display discharge is generated between the scan electrode Y and the sustain electrode Z every sustain pulse sus.

After the sustain discharge is finished, an erase period begins. During the erase period, an erase ramp waveform ers whose voltage gradually increases to the sustain voltage Vs is supplied to the sustain electrodes Z. The erase ramp waveform ers generates an erase discharge between the scan electrode Y and the sustain electrode Z. Thus, wall charges remaining in the main discharge cells 70 and the sub discharge cells 71 of the whole screen are erased.

As described above, according to a PDP, and a method and apparatus for driving the PDP in accordance with the third embodiment of the present invention, a metal bus electrode is overlapped with a horizontal diaphragm to minimize decrease in the aperture ratio due to the metal bus electrode. By moving the position of the horizontal diaphragm toward a discharge space where a discharge occurs, emission efficiency of phosphors formed on the horizontal diaphragm can be increased.

Furthermore, a plasma discharge is generated within a sub discharge cell during a scan time to generate priming charged particles. The priming charged particles are supplied to a main discharge cell to be scanned next item and an address discharge thus occurs rapidly and safely. As a result, an exhaust is facilitated, emission efficiency of a PDP is increased, and address high-speed driving is possible.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display panel including an upper substrate in which scan electrodes and sustain electrodes are formed, and a lower substrate in which address electrodes, horizontal diaphragms and vertical diaphragms are formed,
wherein the horizontal diaphragms and the vertical diaphragms intersect one another to form a plurality of discharge cells, and
the discharge cell comprises a main discharge cell on which phosphors are coated, and a sub discharge cell on which magnesium oxide is coated.

2. The plasma display panel as claimed in claim 1, wherein the horizontal diaphragm comprises a first horizontal diaphragm for separating the discharge cell and the discharge cell, and a second horizontal diaphragm for separating the main discharge cell and the sub discharge cell.

3. The plasma display panel as claimed in claim 2, wherein an aperture portion for connecting the main discharge cell and the sub discharge cell is formed in the second horizontal diaphragm.

4. The plasma display panel as claimed in claim 2, wherein the scan electrode is formed on the first horizontal diaphragm.

5. The plasma display panel as claimed in claim 2, wherein the sustain electrode is formed on the second horizontal diaphragm.

6. The plasma display panel as claimed in claim 1, wherein a black matrix for improving contrast is formed on the sub discharge cell.

7. The plasma display panel as claimed in claim 1, wherein phosphors are coated on the side of the sub discharge cell.

8. A method for driving a plasma display panel in which horizontal diaphragms and vertical diaphragms are intersected to form a plurality of discharge cells, comprising the steps of:
allowing sub discharge cells on which magnesium oxide is coated within the discharge cells to generate a priming discharge; and
allowing main discharge cells on which phosphors into which priming charged particles generated by the priming discharge are introduced are coated to generate an address discharge.

9. The method as claimed in claim 8, wherein simultaneously when the main discharge cells generates the address discharge, the sub discharge cells separated by the horizontal diaphragms generate the priming discharge.

10. An apparatus for driving a plasma display panel in which horizontal diaphragms and vertical diaphragms are intersected to form a plurality of discharge cells, the horizontal diaphragms and the vertical diaphragms comprising:
a plurality of discharge cells that are intersected one another, wherein the discharge cells are divided into main discharge cells on which phosphors are coated and sub discharge cells on which magnesium oxide is coated; and
a driving circuit that generates a priming discharge within the sub discharge cells and generates an address discharge within the main discharge cells using priming charged particles generated by the priming discharge.

11. The apparatus as claimed in claim 10, wherein the driving circuit comprises: a scan driving circuit for sequentially supplying a scan pulse to scan electrodes; a data drive circuit for supplying a data pulse synchronized to the scan pulse to address electrodes; and a sustain driving circuit that operates alternately with the scan driving circuit to supply a sustain pulse to sustain electrodes.

12. A surface discharge type AC type plasma display panel including horizontal diaphragms and vertical diaphragms that are formed on a lower substrate to separate respective cells, and bus electrodes formed under an upper substrate, wherein the plasma display panel has a diaphragm structure in which the horizontal diaphragms are thicker in width than the vertical diaphragms,
wherein horizontal grooves having a predetermined width and height are formed in the horizontal diaphragms that separate upper cells and lower cells adjacent in the horizontal direction, and when the upper substrate and the lower substrate are combined, bus electrodes are disposed right on the horizontal grooves in the horizontal direction.

13. The surface discharge type AC type plasma display panel as claimed in claim 12, wherein sustain bus electrodes among the bus electrodes disposed right on the horizontal grooves are integrated into one, so that a voltage is applied to the upper cell and the lower cell at the same time.

14. A plasma display panel, comprising:
a main discharge cell;
a sub discharge cell adjacent to the main discharge cell;
a diaphragm having a plurality of horizontal diaphragms that separates the main discharge cell and the sub discharge cell, and a plurality of vertical diaphragms connected to the horizontal diaphragms; and
an exhaust/charge passage that penetrates the horizontal diaphragms, for guiding charged particles generated from the sub discharge cell to the main discharge cell.

15. The plasma display panel as claimed in claim 14, further comprising:
upper electrodes formed on an upper substrate to generate a discharge in the main discharge cell and the sub discharge cell;
phosphors formed on the horizontal diaphragms and the vertical diaphragms; and
lower electrodes formed on a lower substrate that is opposite to the upper substrate in the direction that the lower electrodes intersect the upper electrodes.

16. The plasma display panel as claimed in claim 15, wherein each of the upper electrodes comprises:
a transparent electrode; and
a metal bus electrode formed at one side of the transparent electrode.

17. The plasma display panel as claimed in claim 16, wherein the metal bus electrode is overlapped with the horizontal diaphragm.

18. A method for driving a plasma display panel including a main discharge cell, a sub discharge cell adjacent to the main discharge cell, a diaphragm having a plurality of horizontal diaphragms that separates the main discharge cell and the sub discharge cell, and a plurality of vertical diaphragms connected to the horizontal diaphragms, and an exhaust/charge passage that penetrates the horizontal diaphragms, for guiding charged particles generated from the sub discharge cell to the main discharge cell, the method comprising the step of:
causing a discharge to occur in the main discharge cell using priming charged particles generated from the sub discharge cell.

19. An apparatus for driving a plasma display panel including a main discharge cell, a sub discharge cell adjacent to the main discharge cell, a diaphragm having a plurality of horizontal diaphragms that separates the main discharge cell and the sub discharge cell, and a plurality of vertical diaphragms connected to the horizontal diaphragms, and an exhaust/charge passage that penetrates the horizontal diaphragms, for guiding charged particles generated from the sub discharge cell to the main discharge cell, the apparatus comprises:
a driving unit for causing a discharge to occur in the main discharge cell using priming charged particles generated from the sub discharge cell.
